(19) United States
(12) Patent Application Publication
(10) Pub. No.: US 2017/0155261 A1
(43) Pub. Date: Jun. 1, 2017

(54) SYSTEM AND METHOD FOR PROTECTING A BATTERY PACK

(71) Applicant: CHERVON (HK) LIMITED, Wanchai (HK)

(72) Inventors: Shibo Chen, Nanjing (CN); Zhuo Wang, Nanjing (CN); Liang Chen, Nanjing (CN)

(21) Appl. No.: 15/358,578

(22) Filed: Nov. 22, 2016

(30) Foreign Application Priority Data
Nov. 30, 2015 (CN) 201510856770.0

(51) Int. Cl. H02J 7/00

(52) U.S. Cl. CPC H02J 7/0029; H02J 7/007; H02J 7/0063; H02J 2007/0067

(57) ABSTRACT

A method is provided for protecting a battery pack. The method includes discharging the battery pack, detecting the temperature T of the battery pack, detecting the discharge current I of the battery pack, detecting the discharge voltage U1 of the battery pack, obtaining an internal resistance R according to the temperature T or the discharge voltage U1, calculating a capacity voltage U2 according to an equation U2=U1+IR, and determining whether the capacity voltage U2 is less than a preset threshold and, if yes, limiting discharging.

### RELATED APPLICATION INFORMATION

This application claims the benefit under 35 U.S.C. §119(a) of Chinese Patent Application No. CN 201510856770.0, filed on Nov. 30, 2015, the disclosure of which is incorporated herein by reference in its entirety.

### FIELD OF THE DISCLOSURE

The present disclosure relates generally to a system and method for protecting a battery pack.

### BACKGROUND OF THE DISCLOSURE

In the field of power tools, battery packs are common power supply devices, which can improve convenience and movability of the power tool.

In order to prevent the battery pack from damage due to over discharge, the battery pack has an over discharge protecting module. The currently known protecting module determines the capacity of the battery pack based on a terminal voltage of the battery pack. When the terminal voltage detected is less than a constant value, the power is cut off.

However, the terminal voltage of the battery pack may be affected by an internal resistance of cells, so that the voltage detected may not reflect the real capacity of the battery pack, especially in low temperatures. When in low temperatures, the internal resistance of cells increases greatly. Thus, known determining methods have large error. Because the protecting module may misjudge the capacity, the battery pack may not supply power even it still has remaining considerable capacity.

The statements in this section merely provide background information related to the present disclosure and may not constitute prior art.

### SUMMARY

In one aspect of the disclosure, a method is provided for protecting a battery pack. The method includes discharging the battery pack, detecting the temperature T of the battery pack, detecting the discharge current I of the battery pack, detecting the discharge voltage U1 of the battery pack, obtaining an internal resistance R according to the temperature T or the discharge voltage U1, calculating a capacity voltage U2 according to an equation U2=U1+IR, determining whether the capacity voltage U2 is less than a preset threshold, and, if yes, limiting discharging.

In another aspect of the disclosure, a system is provided for protecting a battery pack. The system includes a temperature detection module for detecting the temperature of the battery pack, a current detection module for detecting the current of the battery pack, a voltage detection module for detecting the voltage of the battery pack, and a control module being capable of making the battery pack discharge. When the battery pack is discharged, the current detection module detects the discharge current of the battery pack, the voltage detection module detects the discharge voltage of the battery pack and, the control module calculates a capacity voltage U2 according to an equation U2=U1+IR and then controls the battery pack to discharge or not through comparing the capacity voltage U2 and a preset threshold, wherein R is an internal resistance and the control module obtains the internal resistance R according to a detection result of the temperature detection module or the voltage detection module.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of an exemplary combination of a power tool and a battery pack.

FIG. 2 is a block diagram of an exemplary system for protecting the battery pack.

FIG. 3. is a block diagram of another exemplary system for protecting the battery pack.

FIG. 4 is a flowchart of an exemplary method for protecting the battery pack.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the scope of the invention hereinafter claimed, its application, or uses.

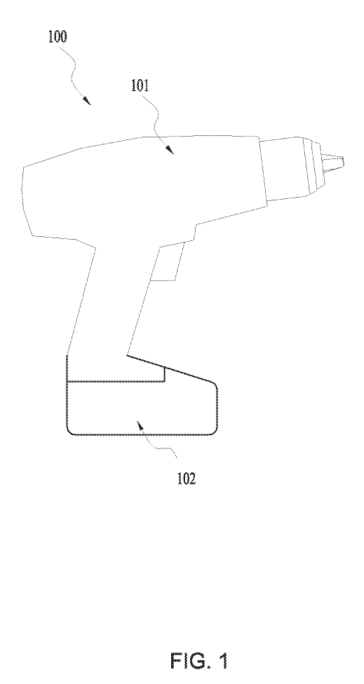

As shown in FIG. 1, a combination 100 includes a power tool 101 and a battery pack 102. The power tool 101 can be a drill. The battery pack 102 is capable of supplying power to the power tool 101. When the battery pack 102 is connected to the power tool 101, the battery pack 102 and the power tool 101 constitute a return circuit wherein the battery pack 102 is discharged.

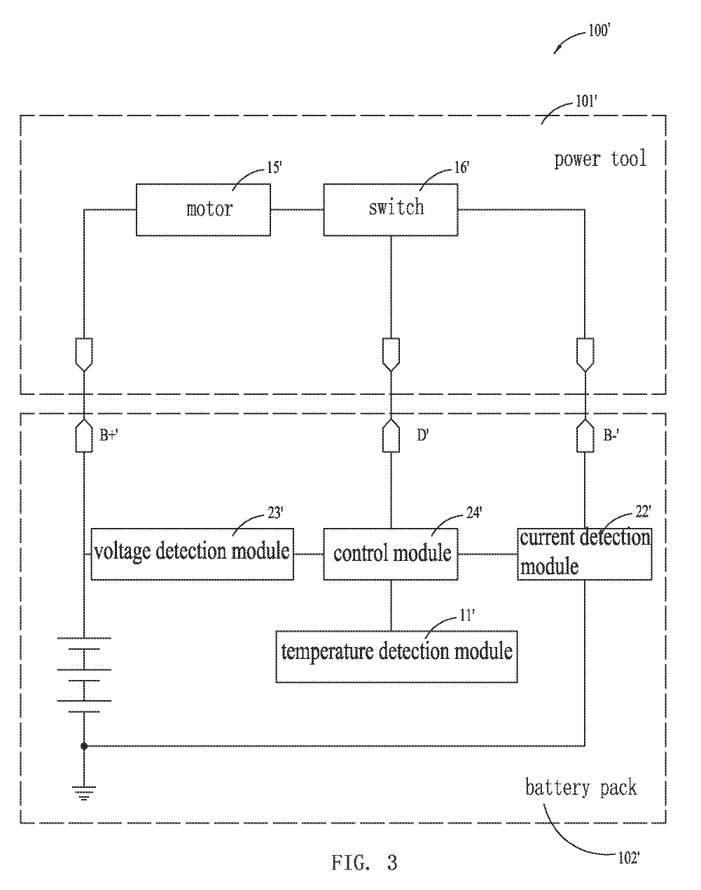

As shown in FIG. 3, a combination 100′ includes a power tool 101′ and a battery pack 102′. The power tool 101′ includes a motor 15′ and a switch 16′. The battery pack 102′ includes a temperature detection module 11′, a current detection module 22′, a voltage detection module 23′ and a control module 24′.

As shown in FIG. 3, the control module 24′ is connected with the temperature detection module 11′, the current detection module 22′ and the voltage detection module 23′.

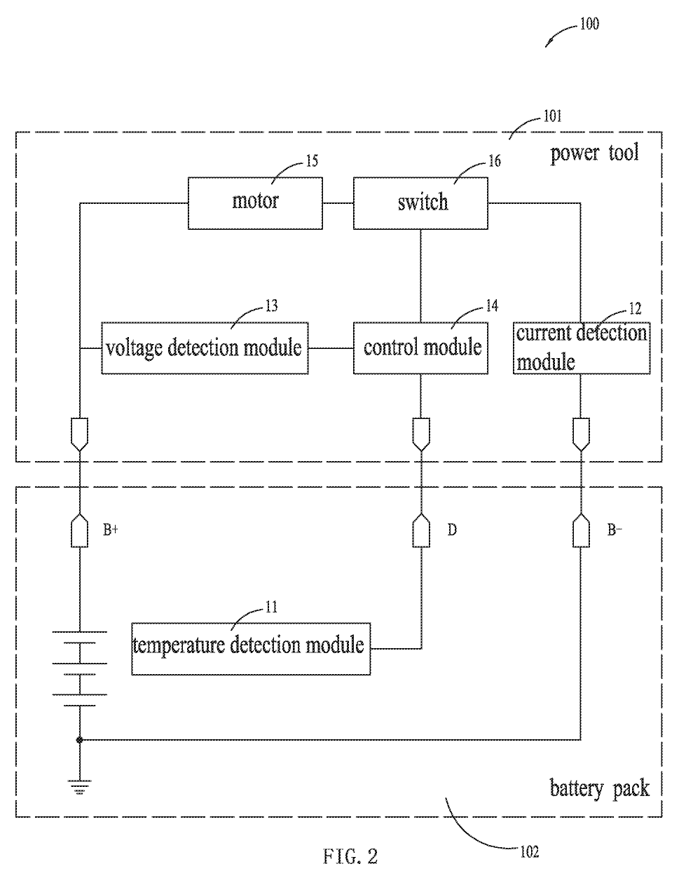

As shown in FIG. 2, the temperature detection module 11 is used to detect the temperature of the battery pack 102. The current detection module 12 is disposed in a discharge circuit of cells in the battery pack 102 for detecting the discharge current of the battery pack 102. The voltage detection module 13 is used to detect the voltage of the battery pack 102.

Specifically, the voltage detection module 13 detects the voltage between a positive terminal B+ and a negative terminal B- of the battery pack 102.

In the combination 100, when the battery pack 102 is controlled to be discharged by the control module 14, the current detection module 12 detects the discharge current of the battery pack 102, the voltage detection module 13 detects the discharge voltage of the battery pack 102, and the control module 14 calculates a capacity voltage U2 according to an equation: U2=U1+IR. Then the battery pack 102 is controlled to be discharged or not by the control module 14 through comparing the capacity voltage U2 and a preset threshold. When the capacity voltage U2 is less than the preset threshold, the battery pack 102 is stopped discharging. In the equation, R is an internal resistance, which is obtained by the control module 14 through the detection result of the temperature detection module 11 or the current detection module 12.

The internal resistance R of the cells can be affected greatly by the temperature of the battery pack 102 and the capacity of the cells in a limiting case. For example, when the capacity of the cells is close to being fully discharged and close to 50%, the internal resistance R of the cells is different even in the same temperature. On the other hand, when the temperature is low and high, the internal resistance R of the cells is different even when the capacity of the cells is the same 50%.

Alternatively, the internal resistance R can be obtained according to the detection results of the temperature detection module 11 and the current detection module 12 jointly. It is noted that, the term ‘the internal resistance R obtained by the control module 14 through the detection result of the temperature detection module 11 or the current detection module 12’ should be comprehended as obtaining the internal resistance R according to at least one of the detection result of the temperature detection module 11 and the current detection module 12. Obtaining the internal resistance R according to the detection results of the temperature detection module 11 and the current detection module 12 jointly is one situation of the term.

Preferably, if the temperature detected is in a preset range, the internal resistance R can be obtained only according to the detection result of the voltage detection module. On the other hand, if the capacity of the cells is in a preset range, the internal resistance R can be obtained only according to the detection result of the temperature detection module.

A real capacity of the cells is unknown when the internal resistance R has not been obtained. So the internal resistance R can be obtained according to the two detection results of the temperature detection module and the current detection module and the single detection result of the temperature detection module alternately, which can reduce the power consumption caused by detection.

Specifically, the control module 14 can control a switch 16 in the discharge circuit of the battery pack 102 so as to control the battery pack 102 to discharge or not.

A motor 15 is arranged in the discharge circuit of the battery pack 102, which acts as an electrical device.

The temperature detection module 11 can be disposed in the battery pack 102 as shown in FIG. 2 so as to detect the temperature of the battery pack 102.

The current detection module 12, the voltage detection module 13 and the control module 14 in FIG. 2 can be disposed in the power tool 101 as shown in FIG. 2, which can be electrically connected with each other through connecting terminals between the battery pack 102 and the power tool 101. For example, the temperature detection module 11 can be connected with the control module 14 of the power tool 101 through a data terminal D of the battery pack 102.

As shown in FIG. 3, in another embodiment, the current detection module 22′, the voltage detection module 23′ and the control module 24/can be disposed in the battery pack 102′.

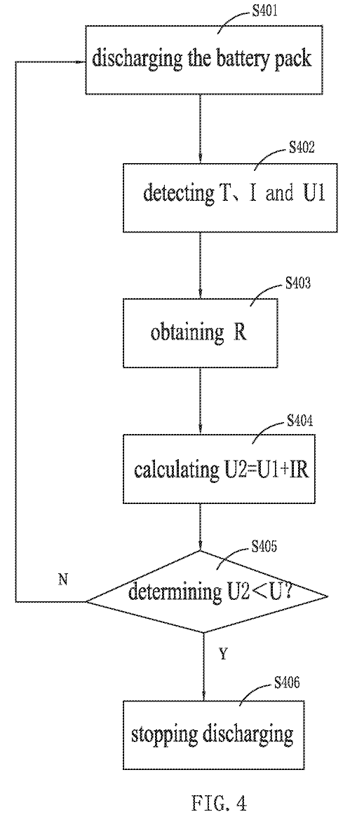

As shown in FIG. 4, the invention hereinafter claimed provides a method for protecting the battery pack, the method includes steps as following:

S401. discharging the battery pack;

S402. detecting the temperature T, the discharge current I and the discharge voltage U1 of the battery pack;

S403. obtaining the internal resistance R according to the temperature T and the discharge current I of the battery pack;

S404. calculating the capacity voltage U2 according to the equation U2=U1+IR;

S405. determining whether the capacity voltage U2 is less than the preset threshold U, if yes, turning to S406, if no, returning to S401; and

S406. stopping discharging.

Further, the internal resistance R is stored in a corresponding control module. The corresponding control module can find the corresponding internal resistance R according to a data combination of the discharge voltage U1 and the temperature T and a corresponding relationship.

Here, the corresponding relationship can be an equation or relationships in other methods.

Specifically, the corresponding relationship is a one to one correspondence. That is, one data combination of the discharge voltage U1 and the temperature T corresponds to one internal resistance R.

However, the internal resistance R can be obtained only according to the discharge voltage U1 or the temperature T as mentioned above.

Otherwise, the switch 16 for controlling on/off in the discharge circuit can be disposed in the battery pack. Or, there may be several switches, some switches are disposed in the power tool and other switches are disposed in the battery pack, so that the battery pack is multi-protected.

The above illustrates and describes basic principles, main features and advantages of the present invention. Those skilled in the art should appreciate that the above embodiments do not limit the claimed invention in any form. Technical solutions obtained by equivalent substitution or equivalent variations all fall within the scope of the claimed invention.

What is claimed is:

1. A method for protecting a battery pack, comprising:
discharging the battery pack;
detecting the temperature T of the battery pack;
detecting the discharge current I of the battery pack;
detecting the discharge voltage U1 of the battery pack;
obtaining an internal resistance R according to the temperature T or the discharge voltage U1;
calculating a capacity voltage U2 according to an equation U2=U1+IR; and
limiting discharging when it is determined that the capacity voltage U2 is less than a preset threshold.

2. The method of claim 1, wherein, if the capacity voltage U2 is greater than the preset threshold, allowing the battery pack to discharge.

3. The method of claim 1, wherein a data combination of the temperature T and the discharge current I corresponds to the internal resistance R.

4. The method of claim 1, wherein the voltage of the battery pack is a voltage between a positive terminal and a negative terminal of the battery pack.

5. The method of claim 1, wherein limiting discharging is realized by the battery pack or a power tool causing the battery pack to discharge.

6. A system for protecting a battery pack, comprising:
a temperature detection module for detecting the temperature of the battery pack;
a current detection module for detecting the current of the battery pack;
a voltage detection module for detecting the voltage of the battery pack; and
a control module being capable of making the battery pack discharge;
wherein, when the battery pack is discharged, the current detection module detects the discharge current of the battery pack, the voltage detection module detects the discharge voltage of the battery pack and, the control module calculates a capacity voltage U2 according to an equation U2=U1+IR and then controls the battery pack to discharge or to not discharge through comparing the capacity voltage U2 and a preset threshold, wherein R is an internal resistance and the control module obtains the internal resistance R according to a detection result of the temperature detection module or the voltage detection module.

7. The system of claim 6, wherein when the capacity voltage U2 is less than the preset threshold and the battery pack is limited to discharge by the control module.

8. The system of claim 6, wherein the temperature detection module is disposed in the battery pack.

9. The system of claim 6, wherein at least one of the current detection module, the voltage detection module and the control module is disposed in the battery pack.

10. The system of claim 6, wherein at least one of the current detection module, the voltage detection module and the control module is disposed in a power tool which can be adapted to the battery pack.
